(19) United States
(12) Patent Application Publication
(10) Pub. No.: US 2025/0171097 A1
(43) Pub. Date: May 29, 2025

(54) BICYCLE SEAT TUBE CAPABLE OF ENHANCING STRUCTURAL STRENGTH

(71) Applicant: J.D COMPONENTS CO., LTD., CHANG HUA HSIEN (TW)

(72) Inventor: NIEN-TENG KUO, CHUANG HUA HSIEN (TW)

(21) Appl. No.: 18/946,029

(22) Filed: Nov. 13, 2024

(30) Foreign Application Priority Data
Nov. 24, 2023 (TW) 112212835

(51) Int. Cl. B62J 1/08

(52) U.S. Cl. CPC B62J 1/08

(57) ABSTRACT

A bicycle seat tube extends along an axial direction and includes a tube head, a tube tail, and a tube body. The tube body has top and bottom ends thereof integrally connected to the tube head and the tube tail, respectively. The tube body is divided in relation to the axial direction into a front support section, a rear support section, and two side support sections opposite to each other and integrally connected between the front support section and the rear support section. The thickness of the front support section is greater than the thickness of the rear support section. As such, the bicycle seat tube of the present invention utilizes varying thicknesses at the front and rear sides of the tube body to achieve effects of enhancing structural strength and extending lifespan.

### BACKGROUND OF THE INVENTION

### 1. Field of the Invention

The present invention relates to bicycle seat tubes and more particularly, to a bicycle seat tube capable of enhancing structural strength.

### 2. Description of the Related Art

The primary function of a bicycle seat tube is to support the saddle. In addition to bearing the rider's weight, it must also withstand the forces generated by front-to-back movement during riding. However, most conventional seat tubes have uniform thickness throughout or have the same thickness at both the front and rear, lacking specific reinforcement in the front area. This design may lead to insufficient structural strength, making the front area prone to breakage under repetitive front-to-back forces over time, posing a risk during riding. Therefore, there is room for structural improvement in conventional bicycle seat tubes.

### SUMMARY OF THE INVENTION

It is one objective of the present invention to provide a bicycle seat tube, which has a thickness varying in different areas at front and rear sides to enhance structural strength.

To attain the above objective, the bicycle seat tube of the present invention extends along an axial direction and comprises a tube head, a tube tail, and a tube body. The tube body has a top end integrally connected to the tube head and a bottom end integrally connected to the tube tail. The tube body has an annular cross-sectional shape, and the tube body is divided in relation to the axial direction into a front support section, a rear support section opposite to the front support section, and two side support sections opposite to each other and integrally connected between the front support section and the rear support section. A thickness of the front support section is greater than a thickness of the rear support section.

It can be seen from the above that the tube body provided by the present invention utilizes a design in which the thickness of the front support section is greater than the thickness of the rear support section, so that the structural strength of the front support section can be effectively enhanced. This design reduces the likelihood of breakage in the front support section, thereby achieving an effect of extending lifespan.

Preferably, the thickness of the front support section and the thickness of the rear support section both remain consistent along the axial direction, and an axis of the tube head and an axis of the tube tail are both eccentric relative to the axial direction.

Preferably, the thickness of the front support section and the thickness of the rear support section both gradually decrease along the axial direction from the tube tail toward the tube head, and an axis of the tube tail is eccentric relative to the axial direction.

Preferably, the thickness of the front support section and the thickness of the rear support section both gradually decrease along the axial direction from the tube head toward the tube tail, and an axis of the tube head is eccentric relative to the axial direction. Preferably, the thickness of the front support section is defined as T1, and the thickness of the rear support section is defined as T2. They satisfy a following relationship: T1−T2≥0.1 mm.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an axially sectional view of a bicycle seat tube of a first embodiment of the present invention.

FIG. 2 is a sectional view taken along line 2-2 of FIG. 1.

FIG. 3 is an axially sectional view of a bicycle seat tube of a second embodiment of the present invention.

FIG. 4 is an axially sectional view of a bicycle seat tube of a third embodiment of the present invention.

### DETAILED DESCRIPTION OF THE INVENTION

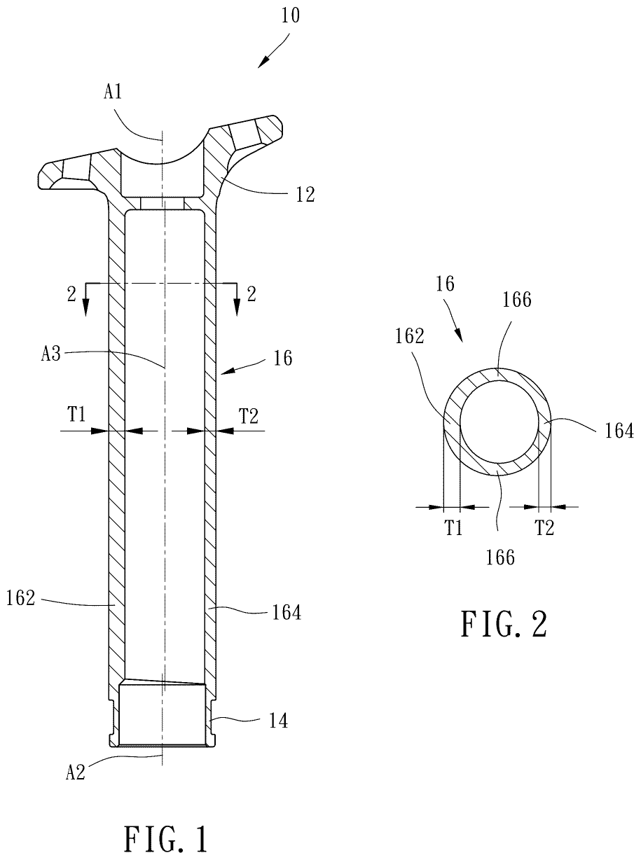

Referring to FIGS. 1-2, a bicycle seat tube 10 of a first embodiment of the present invention comprises a tube head 12, a tube tail 14, and a tube body 16. The tube head 12 is assembled with a saddle (not shown). The top and bottom ends of the tube body 16 are integrally connected to the tube head 12 and the tube tail 14, respectively, and the cross-sectional shape of the tube body 16 is annular. The tube body 16 extends along an axial direction A3, and the tube body 16 is divided in relation to the axial direction A3 into a front support section 162, a rear support section 164 opposite to the front support section 162, and two opposite side support sections 166 integrally connected between the front support section 162 and the rear support section 164. The front support section 162 faces the forward direction of the bicycle, while the rear support section 164 faces the backward direction of the bicycle. In this embodiment, an axis A1 of the tube head 12 and an axis A2 of the tube tail 14 are both eccentric relative to the axial direction A3. As a result, after machining the tube body 16 along the axial direction A3, the thickness T1 of the front support section 162 and the thickness T2 of the rear support section 164 remain consistent along the axial direction A3, while ensuring that the thickness T1 of the front support section 162 is greater than the thickness T2 of the rear support section 164. Further, T1 and T2 satisfy a following relationship: T1−T2≥0.1 mm.

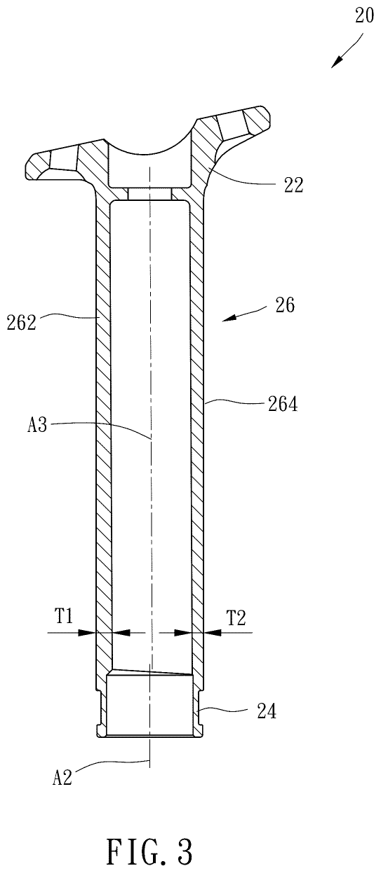

Please refer to FIG. 3, the main structure of the bicycle seat tube 20 of the second embodiment is approximately the same with the first embodiment, but one of the differences therebetween is that only the axis A2 of the tube tail 24 is eccentric relative to the axial direction A3. As a result, after machining the tube body 26 along the axial direction A3, the thickness T1 of the front support section 262 and the thickness T2 of the rear support section 264 gradually decrease along the axial direction A3 from the tube tail 24 toward the tube head 22. However, overall, the thickness T1 of the front support section 262 remains greater than the thickness T2 of the rear support section 264. T1 and T2 also satisfy the following relationship: T1−T2≥0.1 mm.

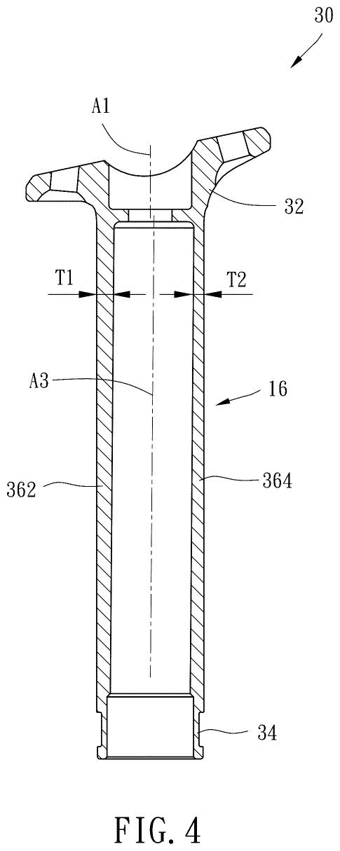

Please refer to FIG. 4, the main structure of the bicycle seat tube 30 of the third embodiment is approximately the same with the first embodiment, but one of the differences therebetween is that only the axis A1 of the tube head 32 is eccentric relative to the axial direction A3. As a result, after machining the tube body 36 along the axial direction A3, the thickness T1 of the front support section 362 and the thickness T2 of the rear support section 364 gradually decrease along the axial direction A3 from the tube head 34 toward the tube tail 34. However, overall, the thickness T1 of the front support section 362 remains greater than the thickness T2 of the rear support section 364. T1 and T2 also satisfy the following relationship: T1−T2≥0.1 mm.

As indicated above, the tube body 16, 26, 36 provided by the present invention utilizes a design of T1>T2 to effectively enhance the structural strength of the front support section 162, 262, 362. This can reduce the likelihood of breakage in the front support section 162, 262, 362 to achieve an effect of extending lifespan.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A bicycle seat tube comprising:
a tube head;
a tube tail; and
a tube body integrally connected between the tube head and the tube tail and having an annular cross-sectional shape, the tube body extending along an axial direction and being divided in relation to the axial direction into a front support section, a rear support section opposite to the front support section, and two side support sections opposite to each other and integrally connected between the front support section and the rear support section, wherein a thickness of the front support section is greater than a thickness of the rear support section.

2. The bicycle seat tube as claimed in claim 1, wherein the thickness of the front support section and the thickness of the rear support section both remain consistent along the axial direction.

3. The bicycle seat tube as claimed in claim 2, wherein an axis of the tube head and an axis of the tube tail are eccentric relative to the axial direction.

4. The bicycle seat tube as claimed in claim 1, wherein the thickness of the front support section and the thickness of the rear support section gradually decrease along the axial direction from the tube tail toward the tube head.

5. The bicycle seat tube as claimed in claim 4, wherein an axis of the tube tail is eccentric relative to the axial direction.

6. The bicycle seat tube as claimed in claim 1, wherein the thickness of the front support section and the thickness of the rear support section gradually decrease along the axial direction from the tube head toward the tube tail.

7. The bicycle seat tube as claimed in claim 6, wherein an axis of the tube head is eccentric relative to the axial direction.

8. The bicycle seat tube as claimed in claim 1, wherein the thickness of the front support section is defined as T1, and the thickness of the rear support section is defined as T2; T1 and T2 satisfy a following relationship: T1−T2≥0.1 mm.
